(19) United States
(12) Patent Application Publication
(10) Pub. No.: US 2025/0026426 A1
(43) Pub. Date: Jan. 23, 2025

(54) HOLDING DEVICE

(71) Applicant: SKS metaplast Scheffer-Klute GmbH, Sundern (DE)

(72) Inventors: Karsten Grabski, Ense (DE); Sven Kordes, Sundern (DE); Alexander Nöcker, Sundern (DE)

(21) Appl. No.: 18/678,906

(22) Filed: May 30, 2024

(30) Foreign Application Priority Data
Jul. 18, 2023 (EP) 23 186 107.1
Aug. 11, 2023 (EP) 23 191 143.9

(51) Int. Cl. B62J 11/00

(52) U.S. Cl. CPC B62J 11/00

(57) ABSTRACT

A holding device for attaching an add-on component to a handlebar-controlled vehicle includes a fastening device to fasten the holding device to the vehicle and a connecting device to connect the add-on component to the fastening device. The connecting device includes a first adapter unit and a second adapter unit. The first adapter unit includes a retaining device for mounting the second adapter unit. The retaining device includes a groove element for positively locking the second adapter unit to the first adapter unit.

### CROSS REFERENCE TO RELATED APPLICATIONS

This application claims priority under 35 U.S.C. § 119(a)-(d) to European application No. 23186107.1 filed on Jul. 18, 2023, and European application No. 23191143.9 filed on Aug. 11, 2023, the entire contents of which are hereby incorporated by reference.

### TECHNICAL FIELD

The present disclosure relates to a holding device for attaching an add-on component, such as a mobile terminal and, in particular, a smartphone, a water bottle holder, a mudguard, a saddle bag, a pannier, a lighting element, an air pump unit, a tool unit or the like to a handlebar-controlled vehicle, such as a bicycle, comprising a fastening device for fastening the holding device to the handlebar-controlled vehicle and a connecting device for connecting the mobile terminal to the fastening device.

### BACKGROUND

Handlebar-controlled vehicles, such as bicycles, e-bikes, quads, jet skis, mofas, mopeds, motorcycles and the like, are controlled by means of a handlebar device having at least one handlebar. Furthermore, the use of the aforementioned add-on components, and in particular mobile terminals such as smartphones, tablets, navigation devices, cameras and the like, is very popular among users of handlebar-controlled vehicles.

DE 10 2017 128 167 A1 disclosed a holding device for a bicycle for connecting a mobile terminal. To connect the mobile terminal, a mounting plate with lug-type projections is used, which forms a bayonet lock with a receiving space, at the end of which there are also lugs that protrude radially into the receiving space. The mounting plate has a diameter of 40 mm or more.

The large diameter of the mounting plate has proven to be inconvenient in practice, especially when the bracket has to fit between other attachments such as the brake lever and bell or on the frame of the vehicle. The bayonet lock works only when the lugs on the mounting plate are in a certain orientation, so that a user must spend a noticeable amount of time establishing the connection, during which time he needs to focus a significant amount of his attention to ensure that the connection is made securely. In addition, the large mounting plate has a significant impact on the appearance of the bike. Furthermore, the manufacturing costs for the large mounting plate with the bayonet lock are high.

### SUMMARY

It is therefore the object of the present disclosure to provide a holding device for a handlebar-controlled vehicle, which allows greater operating comfort. Furthermore, the holding device should, in particular, have a small installation space and preferably be inexpensive to manufacture.

The disclosed holding device for attaching at least one add-on component, such as a mobile terminal, in particular a smartphone, a water bottle holder, a mudguard, a saddle bag, a pannier, a lighting element, an air pump unit, a tool unit or the like to a handlebar-controlled vehicle, such as a bicycle, comprises: at least one fastening device for fastening the holding device to the vehicle; and at least one connecting device for connecting the mobile terminal to the fastening device.

The connecting device has at least a first adapter unit with at least one retaining device for mounting a second adapter unit and wherein the retaining device has at least one groove element for positive locking of the connection.

Preferably, at least the first adapter unit is firmly connected, in particular in one piece, to the fastening device or formed thereon and/or detachably connected to the fastening device.

The disclosed holding device has many advantages. A significant advantage of the disclosed holding device is that the groove element is designed to secure the connection to the first adapter unit. Because the retaining device only has to comprise the groove element and no mechanically moving components, the first adapter unit can be designed to be particularly small and particularly flat, i.e., with a small overall height. This allows the holding device to be manufactured particularly cost-effectively. The holding device is also suitable for installation directly by a vehicle manufacturer. Furthermore, the groove element allows for a simple and convenient securing of the connection, e.g., by an element which is movable and engages in the groove and in particular also clamps itself therein. Furthermore, such a groove element can be used to secure plug connections, wherein a plug connection can be established and released again particularly intuitively and quickly by a user, e.g., by simple plugging and unplugging.

Preferably, at least the shaped element of the retaining device and in particular the retaining device of the first adapter unit is designed to be at least axially symmetrical with respect to at least a first plane of symmetry and in particular also to a second plane of symmetry. Preferably, the second plane of symmetry extends transversely, in particular at right angles, to the first plane of symmetry. In particular, the planes of symmetry extend through a central axis of the holding device. Advantageously, the retaining device has a geometry which allows a user to accommodate a second adapter unit and in particular the add-on component in different orientations or angular positions relative to the central axis. This allows the user to better adapt the orientation of the add-on component to his needs.

Particularly preferably, the groove element extends at least partially circumferentially around a shaped element of the retaining device which is formed essentially along a central axis. In particular, the groove element preferably extends transversely to the central axis at least partially along the circumference of the shaped element. Advantageously, the groove element thereby forms a region that can be engaged at the rear in the direction of the central axis and/or an undercut region into which a shaped element, such as an arm of a clasp unit or the like, can engage in order to produce a secure and positive-locking connection that cannot be easily removed. Another advantage is that the groove element can absorb forces particularly effectively and divert them in the direction of the fastening device.

Preferably, the shaped element has at least one polygonal cross section, preferably essentially constant along the central axis, and preferably a rectangular cross section and particularly preferably a square cross section. Advantageously, the polygonal shaped element allows a torsion-proof connection with a fixed orientation or angular position relative to the central axis between the first adapter unit and the second adapter unit.

Preferably, the first adapter unit has a small maximum length extension essentially transverse to the central axis and in particular a small maximum outer diameter or a small maximum distance. In the following, the maximum outer diameter is used as an example, wherein the term is interchangeable throughout the application with the terms “maximum length extension transverse to the central axis” and/or “maximum distance.” Advantageously, the first adapter unit has a maximum outer diameter of less than 50 mm, preferably less than 40 mm and particularly preferably less than 30 mm. In addition, even smaller maximum diameters of less than 20 mm or 15 mm or even 10 mm are possible. Preferably, the fastening device of the holding device on the vehicle has a maximum outer diameter of less than 50 mm, preferably less than 40 mm and particularly preferably less than 30 mm. In addition, even smaller maximum diameters of less than 20 mm or 15 mm or even 10 mm are possible. Advantageously, the first adapter unit and the fastening device can be mounted at various locations on the vehicle, in particular without them being particularly visually prominent, such as on a handlebar device. In particular, the holding device can be designed to be small enough in diameter that the diameter of the fastening device on the vehicle approximately corresponds to a diameter of a steering rod or a mounting fixture on the steering rod of a handlebar stem. In addition, the maximum outer diameter can also be even smaller.

Particularly preferably, the fastening device is mountable and/or mounted on the vehicle on a handlebar stem as part of a handlebar device of a vehicle, a bicycle frame, a bicycle fork, a saddle or the like. The variant in which the fastening device, including the first adapter unit of the connecting device, can be mounted on the vehicle is advantageous. Furthermore, the holding device is suitable to be installed directly by a vehicle manufacturer during vehicle assembly, because the assembly can be carried out here, for example, by a simple screw connection. Advantageously, when mounted on a handlebar stem of the handlebar device, a handlebar remains free for other or further and in particular different holding devices.

Advantageously, the fastening device on the vehicle can also be mounted and in particular screwed directly to a steering rod, a handlebar or to another part of the handlebar device. Advantageously, the fastening device of the holding device on the vehicle has a screw unit with at least one screw. Preferably, the handlebar device also comprises at least one handlebar fork and/or one steering rod and/or one handlebar. In particular, the fastening device can alternatively or additionally comprise at least two parts which can be connected to one another and which together can engage around a handlebar of a two-wheeler and, when connected to one another, fix the fastening device of the holding device to the two-wheeler. Furthermore, the fastening device can also be fastened to a frame element of a frame device or the like on the vehicle.

In particular, at least one second adapter unit is included, which can be received on the first adapter unit. Preferably, the second adapter unit has at least one receptacle for mounting on the first adapter unit. In particular, the receptacle of the second adapter unit has at least one shape which is adapted to the shaped element of the retaining device of the first adapter unit, so that they can be positioned in a positive-locking manner on one another or inside one another even in an unlocked state. This advantageously achieves a secure hold, wherein the second adapter unit is held so that it cannot tilt against the shaped element on the first adapter unit that is on the second adapter unit. Furthermore, a relative displacement of the second adapter unit and of the mobile terminal relative to the first adapter unit is prevented. Preferably, a secure hold is ensured between the first adapter unit and the second adapter unit by the positive-locking contours.

Preferably, the second adapter unit comprises at least one elastically deformable clasp unit for locking the connection. Preferably, at least a partial section of at least the clasp unit is arranged and/or received at least partially within the groove element in a locked state.

Preferably, a cross-sectional shape of at least one portion, such as an arm of the clasp unit or the like, is adapted to a cross-sectional shape of the groove element. Preferably, the groove element and/or the clasp unit have, at least in sections, a round and/or a polygonal and/or multi-cornered cross section. Advantageously, a round or polygonal cross section allows a low resistance to movement of the clasp unit relative to the groove element and vice versa. This allows the clasp unit to easily slide off obstacles such as the shaped element during the picking up and removal.

In particular, the clasp unit is at least partially made of a metallic material, and preferably of a spring steel. Advantageously, metallic materials are particularly robust, durable and wear-resistant. In addition, spring steel is particularly flexible and fatigue-resistant, so that it can be bent elastically without any problem, e.g., to unlock a connection by at least partially deforming the clasp unit. Furthermore, the spring steel automatically returns to its original shape when elastically deformed. Due to the internal material forces, the clasp unit acts like a spring. Advantageously, the clasp unit is in the form if wire and/or made of a wire.

Advantageously, the clasp unit comprises at least one arm and in particular two arms. Preferably, at least one section of an arm of the clasp unit extends, during intended use, across, below and/or above the receptacle, i.e., on the side of the mobile terminal or on a side of the second adapter unit opposite the mobile terminal. Particularly preferably, at least portions of two arms of the clasp unit extend at least partially across, i.e., below and/or above, the receptacle. Advantageously, the second adapter unit can be mounted and locked at the same time by simply slipping it onto the shaped element of the restraint device if the arms of the clasp unit are designed to be elastic, so that when slipped on, they automatically deform against the shaped element of the restraint device due to the forces acting thereon and then slide into the groove element, so that there is a quick-release fastener. For this purpose, the shaped element can, for example, have bevels or curves which make it easier to guide the arms of the clasp unit.

Preferably, arms of the clasp unit are arranged on opposite sides of the receptacle. In particular, the arms run essentially parallel to each other. Advantageously, the arms of the clasp unit enclose the shaped element of the retaining device in the locked state in the groove element from two opposite sides, so that the locking is particularly secure and in particular tilt-proof.

Expediently, the clasp unit is displaceably mounted on the second adapter unit and/or on the add-on component, in particular along the groove element. By displacement of the clasp unit, the connection can advantageously particularly easily and intuitively be switched into an unlocked position in which the second adapter unit and the add-on component can be removed and in particular pulled off. Advantageously, the clasp unit can be switched into an unlocked position by pulling or pushing, preferably along a direction of the groove element.

In particular, at least one arm of the clasp unit comprises at least one spreading section for unlocking the connection when the clasp unit is displaced. Advantageously, the spreading section can be bent at least inwards and/or outwards in relation to the groove element. Furthermore, the clasp unit can comprise a spreading element which, when the arm of the clasp unit is displaced, causes the arm of the clasp unit to spread and pushes the arm out of the groove element. The clasp unit is then preferably located in an unlocked position and the second adapter unit is removable.

In particular, the add-on component is formed and/or received on the second adapter unit. The add-on component is designed in particular as a receiving shell for a mobile terminal such as a smartphone, a water bottle holder, a mudguard, a saddle bag, a pannier, a lighting element, an air pump unit, a tool unit such as a tool bag, or the like.

Advantageously, the add-on component is designed as a receiving shell for accommodating a mobile terminal. The receiving shell encloses and/or surrounds the mobile terminal at least in part. The receiving shell advantageously allows a secure connection of the mobile terminal to the adapter unit and at the same time protects the mobile terminal from damage, e.g., from stone chips or the like.

Preferably, the second adapter unit, and in particular the receiving shell, comprises at least one magnet unit, in particular for magnetically holding the mobile terminal, e.g., on an inductive charging adapter for power supply and/or for, in particular inductive, charging of the mobile terminal. Advantageously, the magnet unit comprises at least one magnetic body and in particular a plurality of magnetic bodies. Particularly advantageously, magnetic forces can be generated between the second adapter unit and/or the receiving shell and at least one magnetic material of the mobile terminal, which at least support the holding of the mobile terminal on the second adapter unit and/or on the receiving shell. In addition, it is even possible that a holding force of the mobile terminal on the second adapter unit and/or the receiving shell can be generated solely by the magnet unit. It is particularly advantageous if the magnet unit is dimensioned in such a way that the magnetic forces are more than sufficient for vibrations in everyday driving situations. Alternatively, or additionally, the magnetic securing unit can also comprise at least one electromagnet unit, wherein the magnetic forces are not generated permanently but by electrical current which is switchable.

Preferably, the second adapter unit and in particular the received add-on component can be locked relative to the first adapter unit in two different positions, wherein the two positions in particular form an angle of 90° with each other. Advantageously, the second adapter unit can thereby be mounted on the first adapter unit in different angular positions and/or orientations relative to the first adapter unit. This advantageously also allows an add-on component connected to the second adapter unit to be mounted in different positions, e.g., upright or horizontal.

Preferably, the connecting device comprises at least one centering unit for even better centering of the second adapter unit on the first adapter unit. In particular, the centering unit comprises one or more interlocking shaped elements formed on the first adapter unit and/or the second adapter unit, such as ribs, which engage in complementary grooves. The ribs and/or grooves can be formed on the first and/or the second adapter unit. In particular, a plurality of ribs and/or grooves are arranged at an angle to one another. Advantageously, the centering unit allows a particularly precise alignment of the first adapter unit to the second adapter unit.

In particular, the connecting device comprises at least one elastic spring unit, in particular for mounting the second adapter unit on the first adapter unit without play. Preferably, the spring unit comprises at least two and, in particular, two or more spring elements. The spring element is expediently formed as an elastic body, like an elastomer and in particular like rubber. Preferably, the spring element is formed as an elastomer ring or rubber ring and preferably as an O-ring made of an elastomer. The spring unit advantageously compensates for any play between the second adapter unit and the first adapter unit in the received state, so that the holding forces can be transmitted without wear. In particular, a spring element is accommodated on the second adapter unit. Preferably, the elastic spring element is at least partially tensioned against the first adapter unit when slipped on. This ensures a play-free hold.

In particular, a communication unit, such as an NFC chip, is included. Advantageously, the communication unit allows in particular wireless transmission of information and data between the vehicle and the add-on component, in particular a mobile terminal. In this way, for example, information such as current sensor data can advantageously be recorded, in particular contactlessly, and evaluated by the mobile terminal.

Preferably, the holding device comprises at least one intermediate storage unit for electrical energy. In particular, the intermediate storage unit can be interposed between the first adapter unit and the second adapter unit. For this purpose, the intermediate storage unit preferably also has adapter units which can intervene in the first adapter unit and the second adapter unit. The intermediate storage unit can be designed such that it has connecting elements for connection to vehicle-side power sources, wherein the intermediate storage unit is in particular designed such that it can be charged by vehicle-side power sources, for example from a dynamo or a battery of an e-bike. Furthermore, the intermediate storage unit can have connecting elements for the connection to external power sources, wherein the intermediate storage unit is in particular designed such that it can be charged from external power sources, for example via a USB interface. In particular, one or more intermediate storage units are accommodated in a separate housing so that it can be separated in particular from the fastening device.

A handlebar-controlled vehicle according to the disclosure, which is designed in particular as a bicycle, comprises at least one holding device as described above. Advantageous further embodiments result from the entire application. In particular, the holding device is at least partially mounted on a handlebar stem of a handlebar device and/or at least on a frame element of a frame device. The advantage of the holding device is that it is inexpensive to manufacture and small and easy to operate.

Advantageous further developments and properties of the handlebar-controlled vehicle according to the disclosure emerge from the entire application.

### BRIEF DESCRIPTION OF THE DRAWINGS

Further features and advantages of the disclosed exemplary embodiments are described below with reference to the drawings. The same reference signs are used for identical or similar parts and for parts with identical or similar functions.

FIG. 1 is a schematic representation of the holding device according to the disclosure for mounting various add-on components.

FIG. 2 is a schematic perspective view of a handlebar-controlled vehicle according to the disclosure having a holding device according to the disclosure with a mobile terminal, wherein the mobile terminal is locked in a first position.

FIG. 3 is a schematic perspective view of the handlebar-controlled vehicle having the holding device with the mobile terminal, wherein the mobile terminal is locked in a second position.

FIG. 4 is a schematic side view of the holding device in a locked position.

FIG. 5 is a schematic sectional view of the holding device in a locked position.

FIG. 6 is a schematic view of the holding device in a locked position from below.

FIG. 7 is a schematic top view of the holding device in a locked position.

FIG. 8 is a schematic perspective view of the holding device in a locked position.

FIG. 9 is a schematic side view of the holding device in an unlocked position.

FIG. 10 is a schematic sectional view of the holding device in an unlocked position.

FIG. 11 is a schematic view of the holding device in an unlocked position from below.

FIG. 12 is a schematic top view of the holding device in an unlocked position.

FIG. 13 is a schematic perspective view of the holding device in an unlocked position.

FIG. 14 is a schematic side view of the holding device, wherein the second adapter unit is removed from the first adapter unit.

FIG. 15 is a schematic sectional view of the holding device, wherein the second adapter unit is removed from the first adapter unit.

FIG. 16 is a schematic view of the holding device from below, wherein the second adapter unit is removed from the first adapter unit.

FIG. 17 is a schematic top view of the holding device, wherein the second adapter unit is removed from the first adapter unit.

FIG. 18 is a schematic perspective view of the holding device, wherein the second adapter unit is removed from the first adapter unit.

FIG. 19 is a schematic view of a second adapter unit of a further embodiment of a holding device according to the disclosure with grooves of a centering unit from below.

FIG. 20 is a schematic view of a first adapter unit of the further embodiment of a holding device according to the disclosure with ribs of the centering unit from above.

FIG. 21 is a schematic perspective view of the second adapter unit of a further embodiment of the holding device with grooves of a centering unit.

FIG. 22 is a schematic perspective view of the first adapter unit of the further embodiment of a holding device with ribs of the centering unit.

FIG. 23 is a schematic side view of a further embodiment of the holding device according to the disclosure with an elastic spring unit.

FIG. 24 is a schematic sectional view of the holding device with the elastic spring unit.

FIG. 25 is a further schematic sectional view of the holding device with the elastic spring unit.

FIG. 26 is a further schematic sectional view of the holding device with the elastic spring unit.

### DETAILED DESCRIPTION

It is not necessary for a holding device according to the disclosure to have all the features described below. It is also possible for a holding device according to the disclosure to have only individual features of the exemplary embodiment described below.

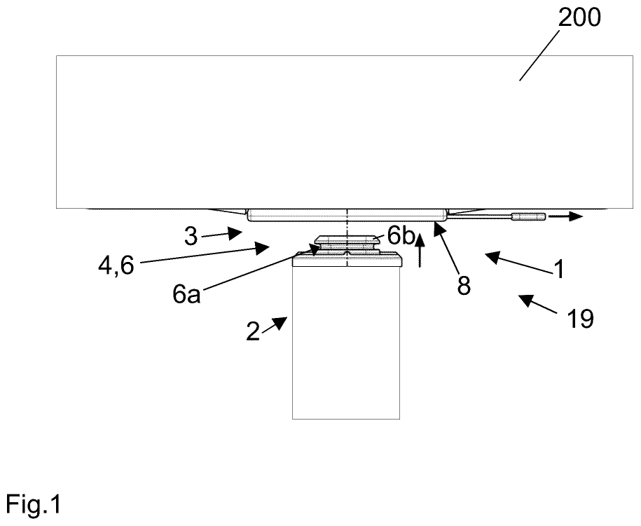

FIG. 1 shows a schematic representation of the holding device 1 according to the disclosure for mounting various add-on components 200. The holding device comprises a fastening device 2 for fastening the holding device to the handlebar-controlled vehicle 100 and a connecting device 3 with a first adapter unit 4 and a second adapter unit 8. The first adapter unit 4 comprises a retaining device 5 with a groove element 6a on which the second adapter unit 8 can be mounted and locked. The add-on component can be, for example, a mobile terminal 200, such as a smartphone 200, a water bottle holder 200, a mudguard 200, a saddle bag 200, a pannier 200, a lighting element 200, an air pump unit 200, a tool unit 200 or the like.

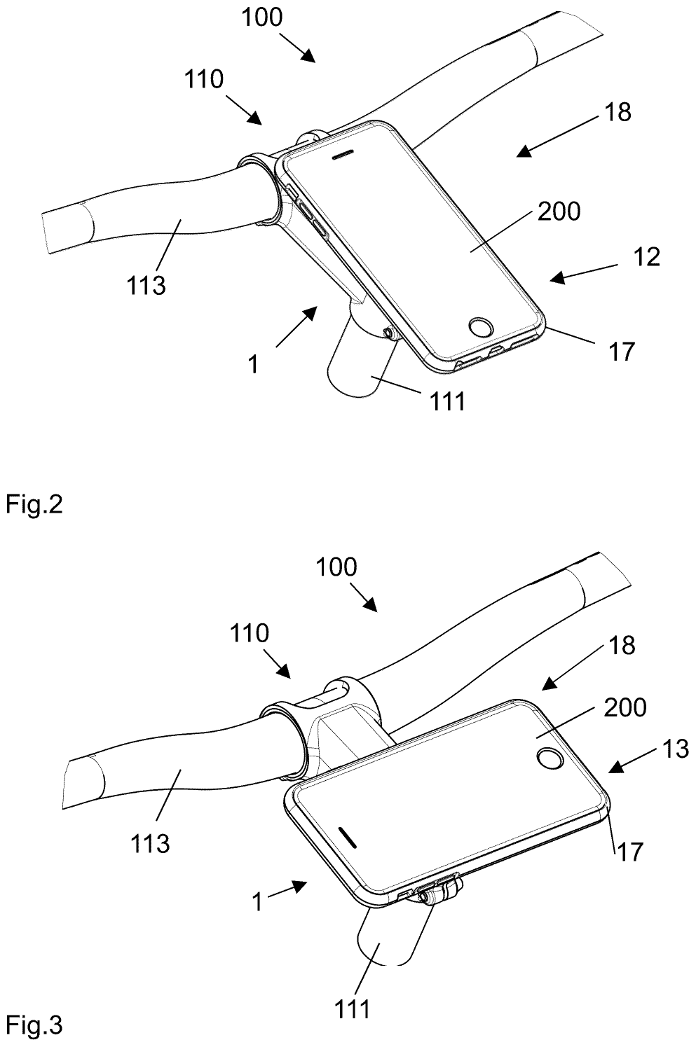

FIG. 2 shows a schematic perspective view of a handlebar-controlled vehicle 100 according to the disclosure with a holding device 1 according to the disclosure. The add-on component 200 is configured here as a mobile terminal 200. Further details are discussed here in reference to this exemplary embodiment. The mobile terminal 200 is held here in a first position 12 of the holding device 1 in a locked position 18, i.e., in this case upright. The holding device 1 is fastened here to a handlebar stem 111 of the handlebar device 110. Alternatively, the holding device I can also be fastened to a handlebar 113 of the handlebar device 110 or the like. The mobile terminal 200 is accommodated here within a receiving shell 17.

FIG. 3 shows a schematic perspective view of the handlebar-controlled vehicle 100 having the holding device 1 with the mobile terminal 200, wherein the mobile terminal 200 is locked in a second position 13, i.e., in this case transversely in relation to the first position 12, see FIG. 2.

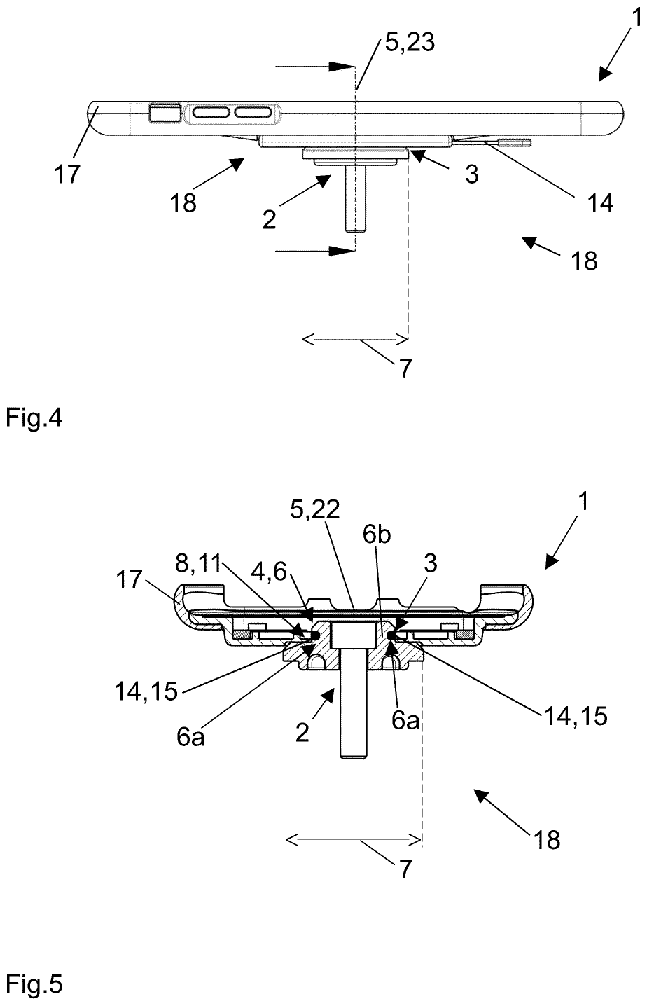

FIG. 4 shows a schematic side view of the holding device 1 in a locked position 18. The holding device 1 is fastened to the vehicle 100 via a fastening device 2. Here, the fastening device 2 comprises a screw for fastening to the handlebar stem 111, see FIGS. 2 and 3. The fastening device 2 is connected to a connecting device 3. The connecting device 3 allows a detachable connection to be established between the first adapter unit 4 and the second adapter unit 8. The holding device 1 extends here along a central axis 5. Furthermore, the fastening device 2 and the first adapter unit 4 of the connecting device 3 are axially symmetrical to a second plane of symmetry 23.

A maximum outer diameter 7 of the first adapter unit 4 and the fastening device 2 is 32 mm, so that neither the first adapter unit 4 nor the fastening device 2 protrude beyond the outer dimensions of the handlebar stem 111, see FIG. 2 and FIG. 3. This makes the holding device 1 particularly suitable for being pre-assembled by a vehicle manufacturer, because the fastening device 2 and the first adapter unit 4 are particularly small. Furthermore, the holding device 1 can be manufactured particularly cost-effectively, for example as an injection-molded part.

The first adapter unit 4 has a retaining device 6 with a shaped element 6b, which extends along the central axis 5. Furthermore, the retaining device 6 comprises a groove element 6a, which here extends circumferentially around the shaped element 6b of the retaining device 6 and forms an undercut or an undercut region.

The second adapter unit 8 here comprises a receptacle 11. The receptacle 11 has a contour which corresponds to a contour of the shaped element 6b of the retaining device 6 of the first adapter unit 4, so that the second adapter unit 8 is mounted here in a positive-locking manner on the first adapter unit 4.

To lock the connection between the first adapter unit 4 and the second adapter unit 8, the holding device 1 here comprises a clasp unit 14 having two arms 15. The clasp unit 13 in this case is made of a spring steel and is elastically bendable. The clasp unit 14 is movably mounted here on the second adapter unit 8. The arms 15 of the clasp unit 14 are accommodated in the groove element 6a, so that a positive locking is provided.

FIG. 4 shows a schematic side view of the holding device 1 in the locked position.

FIG. 5 shows a schematic sectional view of the holding device 1 in the locked position 18.

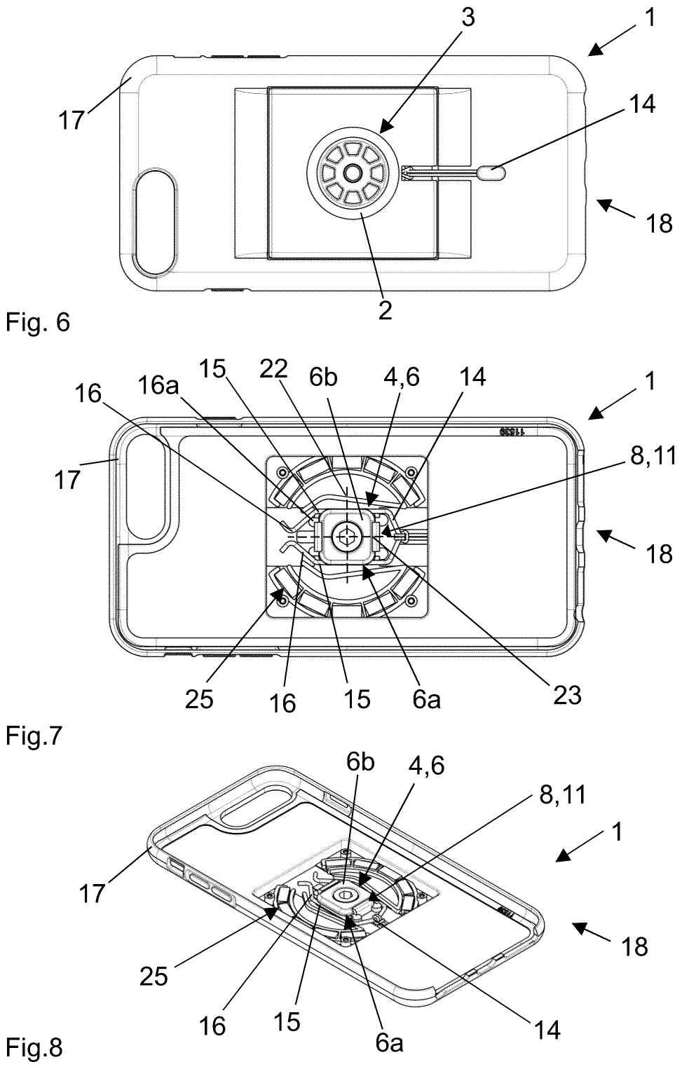

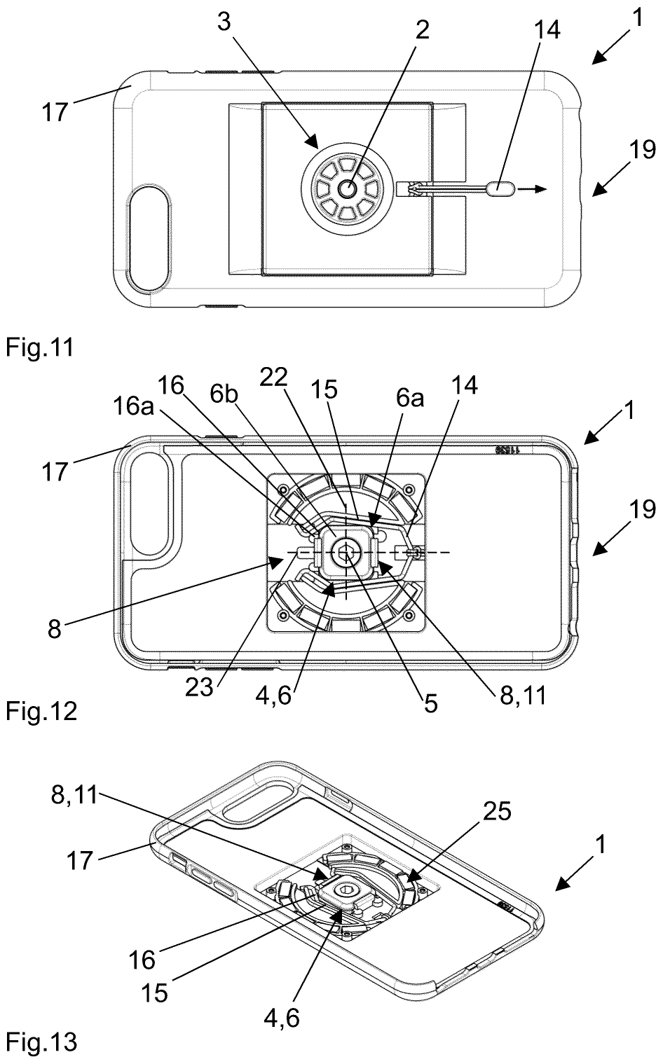

FIG. 6 shows a schematic view of the holding device 1 in the locked position 18 from below. The clasp unit 14 protrudes outward below the receiving shell 17 and can be pulled at the tab in order to switch the connecting device 3 into an unlocked position 19, see FIG. 11.

FIG. 7 shows a schematic top view of the holding device 1 in the locked position 18. The second adapter unit 8 is mounted in a positive-locking manner on the first adapter unit 4. The receptacle 11 of the second adapter unit encloses the shaped element 6b of the retaining device 6 of the first adapter unit 4. A contour of the receptacle 11 is adapted to the square cross-sectional shape of the shaped element 6b of the retaining device 6. The shaped element 6b of the retaining device 6 is axially symmetrical to the two planes of symmetry 22, 23 that are arranged at right angles to each other and extend through the central axis 5. Due to a square cross-sectional shape of the shaped element 6b of the retaining device 6 of the first adapter unit 4, the second adapter unit 8 can be accommodated in two different orientations on the first adapter unit 4 in a rotationally secure manner, see FIGS. 1 and 2.

Two arms 15 of the clasp unit 14, which is displaceably mounted on the second adapter unit 8, extend above the receptacle 11. The arms 15 are received here in the secured position 19 in the groove element 6a, and the connection is in the locked position 18. Each arm 15 of the clasp unit 14 here comprises a spreading section 16 for switching the connection into an unlocked position 19. When the clasp unit is displaced, the spreading sections 16 slide on spreading elements 16a of the clasp unit 14, so that the arms 15 of the clasp unit 14 spread open and the connection is switched into an unlocked position 19, see FIG. 12.

Furthermore, the second adapter unit 8 here comprises a magnet unit 25 with a plurality of magnetic bodies, which are arranged here in a circle around the central axis 5 of the holding device 1. These are used here for magnetically holding and securing the position of the mobile terminal 200 here on an inductive charging adapter for contactless charging of the mobile terminal 200.

FIG. 8 shows a schematic perspective view of the holding device 1 in the locked position 18. Here it can be clearly seen how the arms 15 of the clasp unit 14 are received within the groove element 6a formed on the shaped element 6b of the retaining device 6 of the first adapter unit 4 and lock the connection.

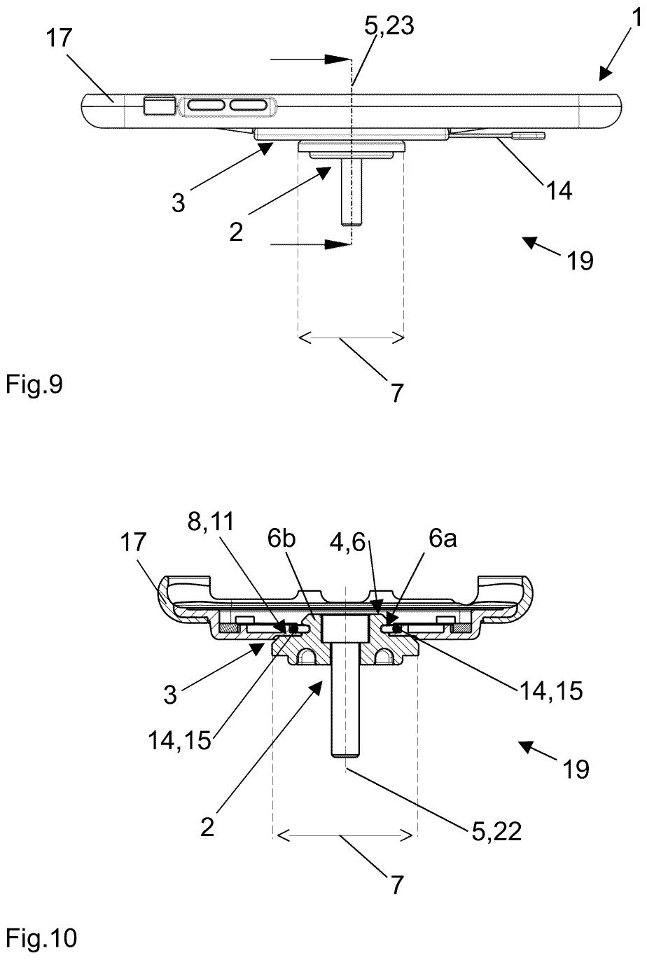

FIG. 9 shows a schematic side view of the holding device 1 in the unlocked position 19. The displaceably mounted clasp element 14 is displaced here or pulled out, see FIG. 4.

FIG. 10 shows a schematic sectional view of the holding device 1 in the unlocked position 19. Due to the displacement of the clasp unit 14, the arms 15 of the clasp unit 14 are no longer accommodated here within the groove element 6a. The second adapter unit 8 can be removed upward. The clasp unit 14 is made of a wire made of spring steel, so that the arms 15 expand elastically outward when the clasp unit 14 is moved. If the clasp unit 14 is released, the clasp unit 14 moves back into the locked position 18 due to the resilient properties of the spring steel.

FIG. 11 shows a schematic view of the holding device 1 in the unlocked position 19 from below. The displaceably mounted clasp unit 14 here is in an outwardly pulled state, e.g., by pressure with a finger of the user, see FIG. 6.

FIG. 12 shows a schematic top view of the holding device 1 in the unlocked position 19. By moving the clasp unit 14, the clasp unit 14 is spread so that the connection is in the unlocked position 19 and the second adapter unit 8 can be removed from the first adapter unit 4.

FIG. 13 shows a schematic perspective view of the holding device 1 in the unlocked position 19. Here it is clearly visible that the arms 15 of the clasp unit 14 are no longer held in the groove element 6a, so that the connection is in the unlocked position 19. The second adapter unit 8 can be easily removed upward along the central axis 5.

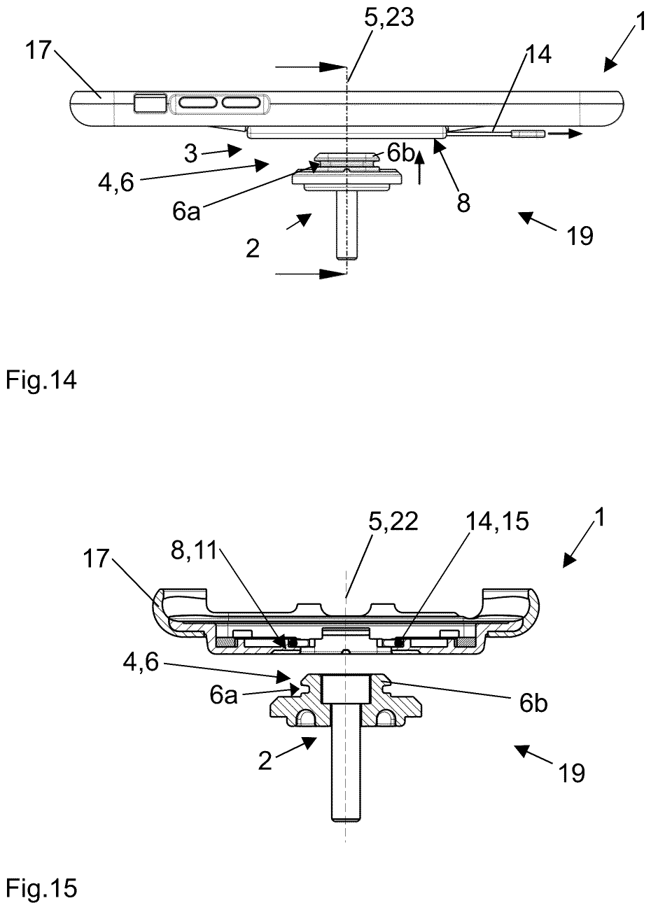

FIG. 14 shows a schematic side view of the holding device 1, wherein the second adapter unit 8 is removed from the first adapter unit 4. The second adapter unit 8 with the receiving shell 17 here is pulled off upward in the unlocked position 19 along the central axis 5.

FIG. 15 shows a schematic sectional view of the holding device 1, wherein the second adapter unit 8 is removed from the first adapter unit 4. Due to the spreading of the clasp unit 14, the arms 15 are not held in the groove element 6a in the unlocked position 19. If the clasp unit 14 is released by the user, it moves back to its original position via elastic return of the spring steel. The arms 15 of the clasp unit 15 then extend over the receptacle 11, as in the locked state, see FIG. 5. When the second adapter unit 8 is slipped onto the first adapter unit 4, the arms 15 of the clasp unit 14 deform elastically and are then automatically held in the groove element 6a of the retaining device 6 of the first adapter unit 4, so that the connection locks automatically when slipped on. Alternatively, the user can spread the arms 15 of the clasp unit 14 by moving them, then slip on the second adapter unit 8 and then release the clasp unit 14, so that it is held in the groove element 6a.

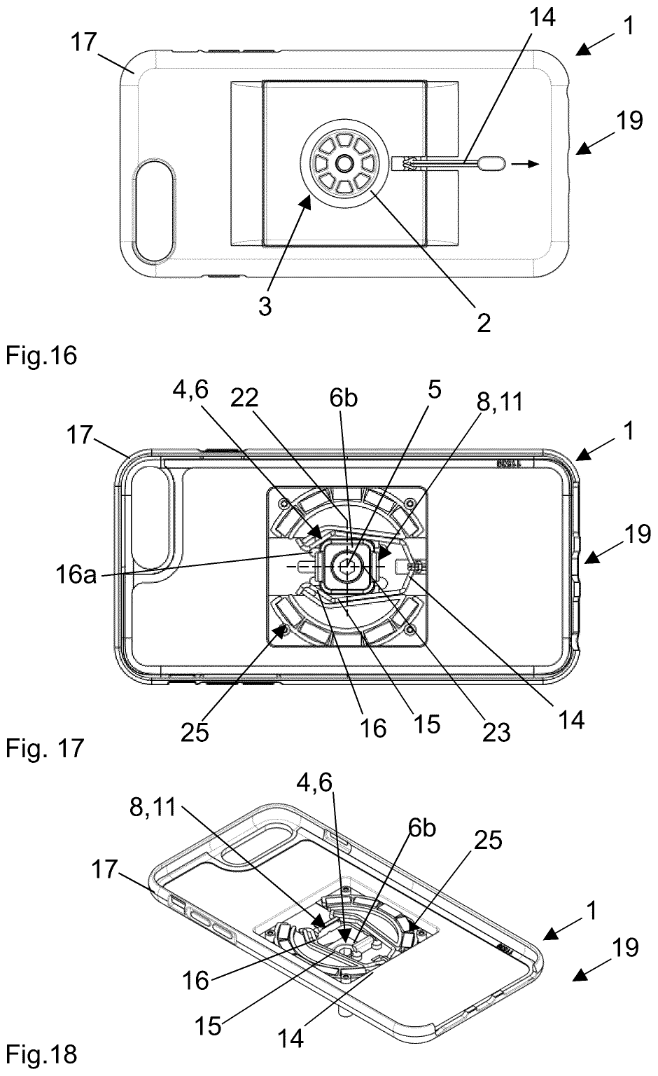

FIG. 16 shows a schematic view of the holding device 1 from below, wherein the second adapter unit 8 is removed from the first adapter unit 4.

FIG. 17 shows a schematic top view of the holding device 1, wherein the second adapter unit 8 is removed from the first adapter unit 4.

FIG. 18 shows a schematic perspective view of the holding device 1, wherein the second adapter unit 8 is removed from the first adapter unit 4.

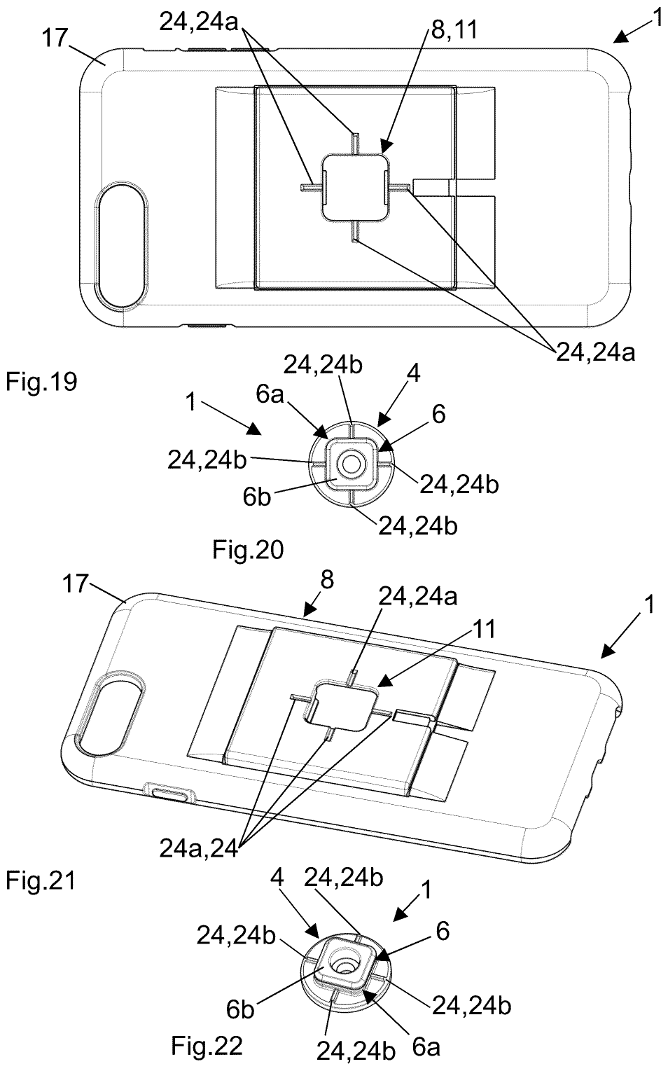

FIG. 19 shows a schematic view of a second adapter unit 8 of a further embodiment of a holding device 1 according to the disclosure with grooves 24a of a centering unit 24 from below. Grooves 24a are formed here on the second adapter unit 8 which engage in ribs 24b that are formed on the first adapter unit 4, see FIG. 20.

FIG. 20 shows a schematic plan view of a first adapter unit 4 of the further embodiment of the holding device 1 according to the disclosure with ribs 24b of the centering unit 24. When the second adapter unit 8 is mounted on the first adapter unit 4, the ribs 24b engage in the grooves 24a and center the second adapter unit 8 in relation to the first adapter unit 4. The grooves 24a and the ribs 24b extend radially outward around the central axis 5. This ensures a fixed and movement-free fit of the second adapter unit 8 on the first adapter unit 4.

FIG. 21 shows a schematic perspective view of the second adapter unit 8 with a centering unit 24 with grooves 24a of another embodiment of the holding device 1 according to the disclosure.

FIG. 22 shows a schematic perspective view of the first adapter unit 4 with ribs 24b of the centering unit 24 according to the further embodiment of the holding device 1 according to the disclosure.

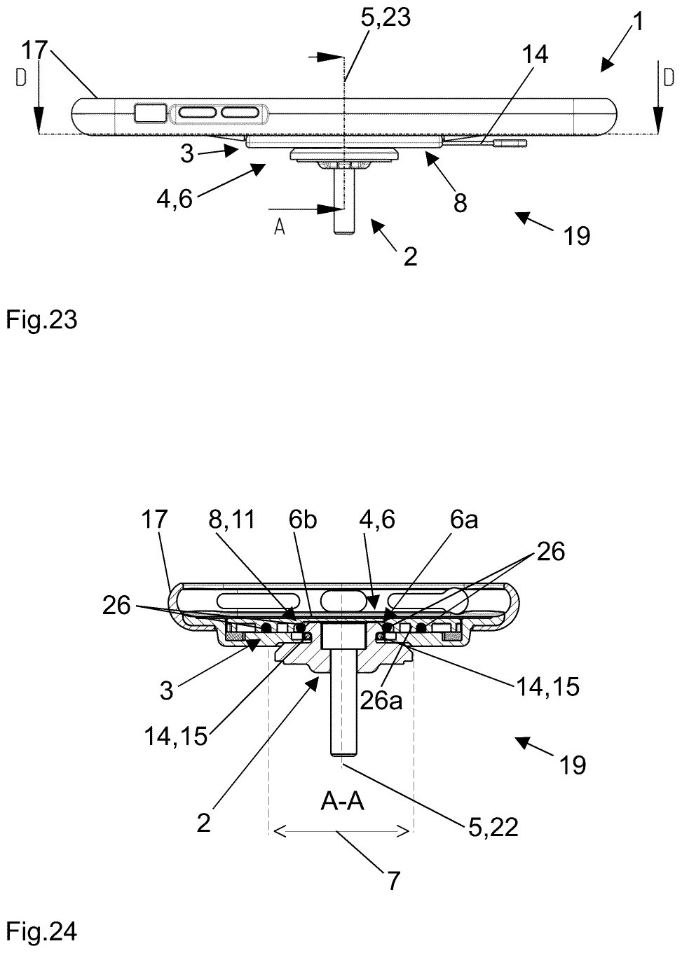

FIG. 23 shows a schematic side view of a further embodiment of the holding device 1 according to the disclosure with an elastic spring unit 26.

FIG. 24 a schematic sectional view of the holding device 1 with the elastic spring unit 26. The spring unit 26 here comprises two spring elements 26, which are made here of an elastomer and are formed here as O-rings 26. The spring elements 26 are mounted here on the second adapter unit 8 directly adjacent to the receptacle 11. The spring elements 26 are arranged opposite one another from the receptacle 11. The O-rings 26 are clamped against the shaped element 6b of the retaining device 6. This allows the second adapter unit 8 to be held on the first adapter unit 4 of the connecting device 3 without play. Holding forces are transmitted here by the spring unit 26 between the second adapter unit 8 and the first adapter unit 4. The spring unit 26 compensates in this for any manufacturing-related play between the second adapter unit 8 and the first adapter unit 4. The spring elements 26 deform when slipped onto the shaped element 6b, so that it is easy to slip them on.

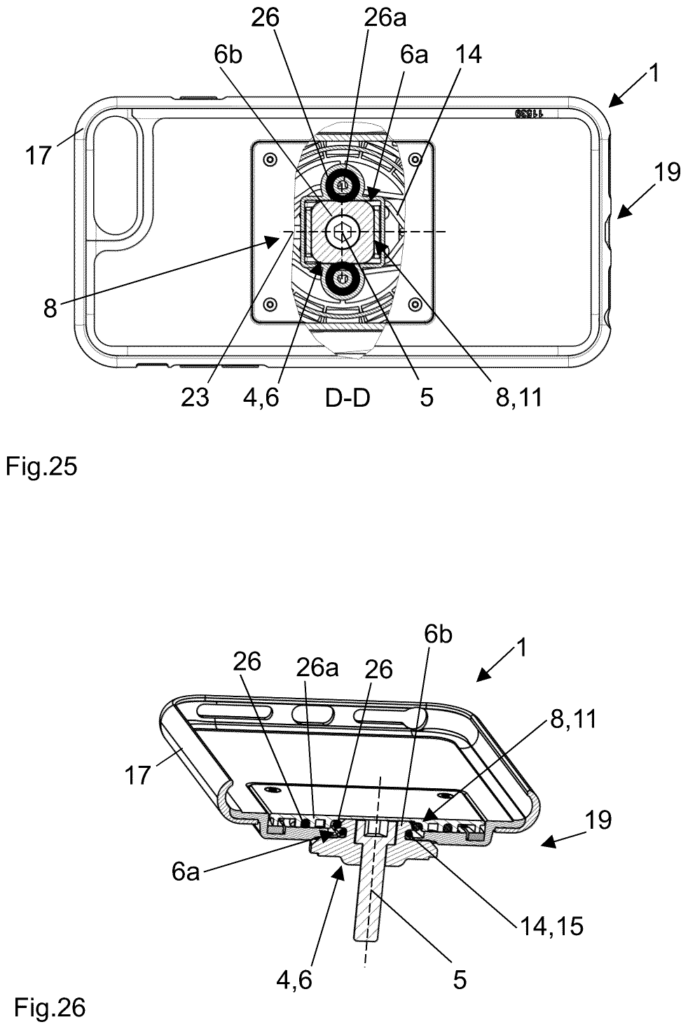

FIG. 25 shows a further schematic sectional view of the holding device 1 with the elastic spring unit 26. In the plan view, the part around the spring unit 26 is shown cut away. The spring elements 26 are slipped here onto receptacles 26a on the second adapter unit 8.

FIG. 26 shows another schematic sectional view of the holding device 1 with the elastic spring unit 26. The arrangement of the spring elements 26 on the receptacles 26a and the function can be clearly seen here again.

What is claimed is:

1. A holding device for attaching an add-on component to a handlebar-controlled vehicle, comprising:
a fastening device to fasten the holding device to the vehicle; and
a connecting device to connect the add-on component to the fastening device, the connecting device comprising a first adapter unit and a second adapter unit, the first adapter unit including a retaining device for mounting the second adapter unit, the retaining device including a groove element for positively locking the second adapter unit to the first adapter unit.

2. The holding device of claim 1, wherein the retaining device is axially symmetrical to a first plane of symmetry and a second plane of symmetry.

3. The holding device of claim 1, wherein the groove element extends at least partially circumferentially around a shaped element of the retaining device that is formed essentially along a central axis.

4. The holding device of claim 3, wherein the shaped element has a square cross section.

5. The holding device of claim 1, wherein the first adapter unit and the fastening device each have a maximum outer diameter of less than 50 mm.

6. The holding device of claim 1, wherein the first adapter unit and the fastening device each have a maximum outer diameter of less than 40 mm.

7. The holding device of claim 1, wherein the first adapter unit and the fastening device each have a maximum outer diameter of less than 30 mm.

8. The holding device of claim 1, wherein the second adapter unit has a receptacle for positive-locking mounting on the retaining device.

9. The holding device of claim 8, wherein the second adapter unit comprises an elastically deformable clasp unit for engaging in the groove element.

10. The holding device of claim 9, wherein first and second arms of the clasp unit extend at least partially over the receptacle.

11. The holding device of claim 9, wherein the clasp unit is displaceably mounted on the second adapter unit, and wherein an arm of the clasp unit comprises a spreading section for unlocking the second adapter unit from the first adapter unit when the clasp unit is displaced.

12. The holding device of claim 1, wherein the add-on component is received on the second adapter unit.

13. The holding device of claim 1, wherein the second adapter unit has a magnet unit for mounting the add-on component on an inductive charging adapter.

14. The holding device of claim 1, wherein the add-on component can be locked relative to the first adapter unit in two different positions, wherein the two different positions form a 90° angle with one another.

15. The holding device of claim 1, wherein the connecting device comprises a centering unit for centering the second adapter unit on the first adapter unit.

16. The holding device of claim 1, wherein the connecting device comprises an elastic spring unit for mounting the second adapter unit on the first adapter unit without play.

17. A handlebar-controlled vehicle, comprising:
the holding device of claim 1, wherein the holding device is at least partially mounted on a handlebar stem, a handlebar device, or a frame device of the vehicle.
